(19) United States
(12) Patent Application Publication
(10) Pub. No.: US 2024/0054522 A1
(43) Pub. Date: Feb. 15, 2024

(54) Industry Gift Voucher with Fence Network: System and Method

(71) Applicants: Matthew John Ecker, Glen Gardner, NJ (US); David Tucker, Chatham, NJ (US)

(72) Inventors: Matthew John Ecker, Glen Gardner, NJ (US); David Tucker, Chatham, NJ (US)

(21) Appl. No.: 18/222,445

(22) Filed: Jul. 15, 2023

Related U.S. Application Data
(60) Provisional application No. 63/391,158, filed on Jul. 21, 2022.

(51) Int. Cl. G06Q 30/0226; G06Q 20/12; G06Q 20/40; G06Q 20/10

(52) U.S. Cl. CPC G06Q 30/0233; G06Q 20/1235; G06Q 20/40; G06Q 20/10

(57) ABSTRACT

The invention relates to a method and system for Industry Gift Voucher (IGV) management in fence networks. The method includes determining a base value, a unique alphanumeric key, and an expiration date to create an IGV; assigning an ownership of the IGV to a first user upon receiving a purchase request from the first user and required information of the first user; transferring the ownership of the IGV to a second user upon receiving a gift request from the first user and required information of the second user; and facilitating redemption of the IGV to the second user to utilize the IGV through at least one enterprise of a plurality of enterprises associated with one of the fence networks, wherein the IGV is circulated within the fence networks.

### TECHNICAL FIELD

Generally, the invention relates to Industry Gift Vouchers (IGFs). More specifically, the invention relates to a method and system for Industry Gift Voucher (IGV) management in fence networks.

### BACKGROUND

Gift cards have long been a popular mechanism for individuals to give a specific amount of money to recipients. Platforms like Amazon.com exemplify the diverse range of gift card options available, offering personalized physical gift cards that can be printed or mailed, as well as email gift cards with various redemption processes. However, existing gift card systems, including those offered by Amazon.com, present several challenges and limitations.

Redemption processes for gift cards often involve cumbersome steps, such as clicking on email links or entering long alphanumeric codes. These complexities may lead to user errors and frustration. Additionally, traditional gift cards are typically restricted to specific retailers or brands, limiting the recipient's options. For instance, if a recipient receives a gift card for a particular restaurant but lives far away from the nearest location, the card loses its utility.

Although attempts have been made to improve gift card convenience and usability, existing solutions fail to address the fundamental problem of recipient confinement to a single brand retailer. The current state of the art, as summarized in a November 2010 New York Times article titled “The More Convenient Gift Card,” acknowledges the ongoing efforts to enhance gift cards but acknowledges the persistent complexity and restrictions.

Therefore, there is a need for an effective solution that overcomes the limitations of existing gift card systems. The proposed method and system provides a gift card that offers greater flexibility and convenience to both givers and recipients. This aims to revolutionize the gift card industry by introducing a novel approach that allows recipients to choose their preferred redemption options, select from a wide range of participating enterprises, and eliminate the restrictions imposed by conventional gift cards.

### SUMMARY OF INVENTION

In one embodiment, a method for Industry Gift Voucher (IGV) management in fence networks is disclosed. The method may include determining a base value, a unique alphanumeric key, and an expiration date to create an IGV. The method may further include assigning ownership of the IGV to a first user upon receiving a purchase request from the first user and required information of the first user. The method may further include transferring the ownership of the IGV to a second user upon receiving a gift request from the first user and required information of the second user. The method may further include facilitating redemption of the IGV to the second user to utilize the IGV through at least one enterprise of a plurality of enterprises associated with one of the fence networks. It should be noted that the IGV may be circulated within the fence networks.

In another embodiment, a system for Industry Gift Voucher (IGV) management in fence networks is disclosed. The system may include a processor and a memory communicatively coupled to the processor. The memory may store processor-executable instructions, which on execution, may further cause the processor to determine a base value, a unique alphanumeric key, and an expiration date to create an IGV. The processor-executable instructions, on execution, may further cause the processor to assign ownership of the IGV to a first user upon receiving a purchase request from the first user and required information of the first user. The processor-executable instructions, on execution, may further cause the processor to transfer the ownership of the IGV to a second user upon receiving a gift request from the first user and required information of the second user. The processor-executable instructions, on execution, may further cause the processor to facilitate redemption of the IGV to the second user to utilize the IGV through at least one enterprise of a plurality of enterprises associated with one of the fence networks. It should be noted that the IGV may be circulated within fence networks.

In yet another embodiment, a non-transitory computer-readable medium storing computer-executable instructions for Industry Gift Voucher (IGV) management in fence networks is disclosed. The stored instructions, when executed by a processor, may cause the processor to perform operations including determining a base value, a unique alphanumeric key, and an expiration date to create an IGV. The operations may further include assigning ownership of the IGV to a first user upon receiving a purchase request from the first user and required information of the first user. The operations may further include transferring the ownership of the IGV to a second user upon receiving a gift request from the first user and required information of the second user. The operations may further include facilitating redemption of the IGV to the second user to utilize the IGV through at least one enterprise of a plurality of enterprises associated with one of the fence networks. It should be noted that the IGV may be circulated within fence networks.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIG. 1 is a block diagram illustrating a system for Industry Gift Voucher (IGV) management in fence networks, in accordance with an embodiment.

FIG. 2 is a block diagram illustrating various modules within a memory of a server configured to manage IGV in fence networks, in accordance with an embodiment.

FIG. 3 illustrates a flowchart of a method for IGV management in fence networks, in accordance with an embodiment.

FIG. 4 illustrates a flowchart of a method for transferring ownership of IGV to a second user, in accordance with an embodiment.

FIG. 5 illustrates a flowchart of a method for facilitating redemption of IGV to a second user, in accordance with an embodiment.

FIG. 6 illustrates a flowchart of a method for buyback of IGV, in accordance with an embodiment.

FIG. 7 illustrates an exemplary process flow for creation of IGV by gifter, in accordance with an embodiment.

FIG. 8 illustrates an exemplary process flow for creation of IGV by producer, in accordance with an embodiment.

FIG. 9 illustrates an exemplary process flow for transferring IGV from recipient to producer for goods or services, in accordance with an embodiment.

FIG. 10 illustrates an exemplary process flow for donating IGV by recipient to producer to nonprofit, in accordance with an embodiment.

FIG. 11 illustrates an exemplary process flow for transferring of IGV from recipient to new recipient, in accordance with an embodiment.

FIG. 12 illustrates an exemplary process flow for transferring of IGV from recipient to fence link, in accordance with an embodiment.

FIG. 13 illustrates an exemplary process flow for transferring of IGV from fence link to producer, in accordance with an embodiment.

FIG. 14 illustrates an exemplary process flow for transferring of IGV from fence link to fence link, in accordance with an embodiment.

FIG. 15 illustrates an exemplary process flow for transferring of IGV from fence link to new recipient, in accordance with an embodiment.

FIG. 16 illustrates an exemplary process flow for IGV expiration while in general circulation, in accordance with an embodiment.

FIG. 17 illustrates an exemplary process flow for IGV expiration while in fence network circulation, in accordance with an embodiment.

FIG. 18 is a block diagram of an exemplary computer system for implementing embodiments consistent with the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

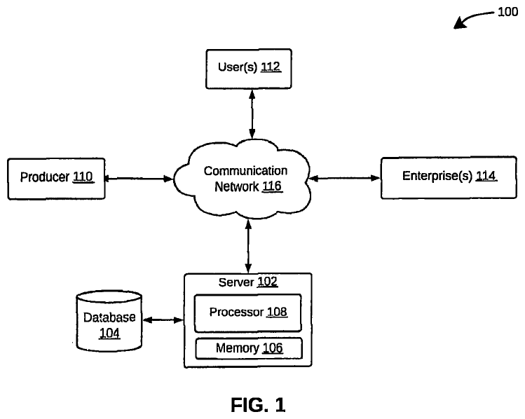

Referring now to FIG. 1, a block diagram of a system 100 for IGV management in fence networks is illustrated, in accordance with an embodiment. The system 100 may be capable of creating and distributing digital tokens (e.g., IGVs) that may be traded between individuals and businesses. These IGVs may be used to obtain discounts on goods and services within a specific network (e.g., fence network) of participating businesses and organizations.

The system 100 may include a server 102, a producer 110, users 112, and enterprises 114. The server 102, the producer 110, the users 112, and the enterprises 114 are configured to communicate with each other via a communication network 116. In other words, the communication network 116 enables seamless communication and data exchange between the server 102, the producer 110, the users 112, and the enterprises 114. Examples of the communication network 116 may include, but are not limited to, a wireless fidelity (Wi-Fi) network, a light fidelity (Li-Fi) network, a local area network (LAN), a wide area network (WAN), a metropolitan area network (MAN), a satellite network, an Internet, a fiber optic network, a coaxial cable network, an infrared (IR) network, a radio frequency (RF) network, and a combination thereof.

The producer 110 may be an entity responsible for managing the IGV. It oversees a creation, distribution, and redemption of IGVs. The producer 110 may set up the rules and parameters for the IGVs, including face values, expiration dates, and incentives for buyback. The producer 110 may also interfaces with the server 102 and database 104 to facilitate various transactions and processes within the system 100.

The users 112 may be individuals that may include a first user (for example, a gifter) and a second user (for example, a recipient) who purchase or receive IGVs, respectively. The users 112 may interact with the system 100 through a communication network116 and the server 102 to perform actions such as purchasing, gifting, redeeming, or transferring IGVs. The IGVs may be fully funded in advance by the gifter and may be redeemed at the point of sale by transferring ownership to a redeeming retailer.

In some embodiments, the system 100 may allow the recipient to choose how the recipient wants to use the IGV. For example, the recipient may either redeem it directly with the producer 110 for goods or services, or they may donate it to a charity or nonprofit organization related to the industry. The recipient may also transfer the IGV to another recipient within the fence network.

The enterprises 114 may be an organisation, a business, a non-profit organisation, a producer's site, a retailer, distributors, suppliers, or an affiliated organisation. The enterprises 114 may interact with the system 100 to accept IGVs as a payment, offer goods or services for redemption, or participate in the buyback process.

In some embodiments, the enterprises 114 may benefit from increased visibility within the fence network and may have an option to discount a sale up to a value of the IGV. In some embodiments, the enterprises 114 may sell the IGV back to the producer 110, earning additional profit.

The server 102 may be a centralized server or a group of decentralized servers that may be responsible to manage flow of IGVs within the fence network. The fence network may refer to a group of closed-loop businesses, organizations, professional services, or coalitions within a specific market or industry. These entities participate in IGV program by accepting the vouchers directly.

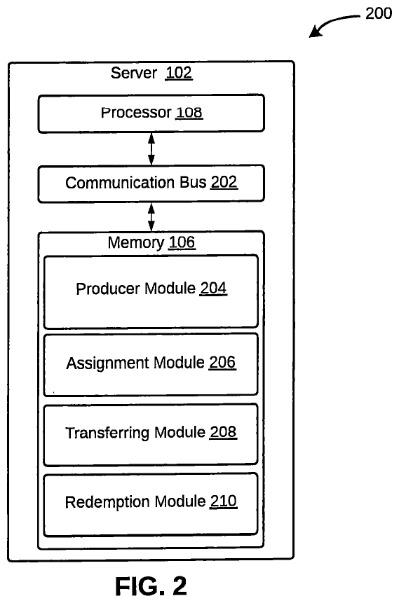

The server 102 may include a memory 106 and a processor 108. The memory 106 may further include various modules that enable the server 102 to manage IGV in the fence networks. These modules are explained in detail in conjunction with FIG. 2.

The memory 106 may store instructions that, when executed by the processor 108, may cause the processor 108 to manage IGV in the fence networks. As will be described in greater detail in conjunction with FIG. 2 to FIG. 7, in order to manage the IGV, the processor 108 in conjunction with the memory 106 may perform various functions including determining a base value, a unique alphanumeric key, and an expiration date to create an IGV, assigning an ownership of the IGV to a first user upon receiving a purchase request from the first user and required information of the first user, transferring the ownership of the IGV to a second user upon receiving a gift request from the first user and required information of the second user, and facilitating redemption of the IGV to the second user to utilize the IGV through at least one enterprise of a plurality of enterprises associated with one of the fence networks.

The memory 106 may also store various data (e.g., user's details, users account information, and user's proof of licenses or certifications, etc.) that may be captured, processed, and/or required by the server 102. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random-Access Memory (DRAM), Static Random-Access memory (SRAM), etc.).

Further, a database 104 may be connected to the server 102 and may be used to store critical information related to the IGV. By way of an example, the database 104 may store data such as users profile details, users account information, users proof of licenses or certifications, IGV details, transaction records, and other relevant information. Additionally, the database 104 may be periodically updated based on various factors, such as new IGV creations, transfers of ownership between gifters and recipients, redemption transactions within the fence network, buyback activities, and changes to participating enterprises or their details.

In some embodiments, the server 102 may be associated with an application (for example, a mobile application or a web application). The application may be accessible by an electronic device that provides a user interface (UI) for various functions related to the IGV. Examples of the electronic device may include, but is not limited to, a computer, a tablet, a smartphone, a smart TV, and a laptop. The application may act as a platform where the producer, gifter, recipient, and enterprises may access and interact with the system 100. Through the UI provided by the mobile application or web application, the users may perform tasks such as, but not limited to, creating IGVs, transferring ownership of IGVs from gifters to recipients, and managing their IGV accounts.

By way of an example, the UI may allow the producer to configure parameters of the IGVs, such as base values, expiration dates, administrative fees, and a predetermined incentive for buyback. The producer may input this information through the mobile application or web application, which then communicates with the server 102 and database 104 to create the IGVs and store their details.

For gifter and recipient, the UI may enable them to view and manage their IGVs. The gifter may select a desired IGVs, specify recipient, and initiate the transfer process. The recipient, on the other hand, may access the UI to claim ownership of received IGVs, view their IGV balance, and choose redemption options.

The UI may also allow the enterprises participating in the system 100 to interact with the server 102 and perform various actions. This may include verifying validity of IGVs, accepting IGVs as payment for goods or services, and initiating the buyback process when desired.

Referring now to FIG. 2, a block diagram 200 of various modules within the memory 106 of the server 102 that is configured to manage IGV in fence networks is illustrated, in accordance with an embodiment of the present disclosure. FIG. 2 is explained in conjunction with elements from FIG. 1. The server 101 may include the processor 108 and the memory 106 communicatively coupled to the processor 108 via a communication bus 202. The memory 106 may store processor instructions. The processor instructions, when executed by the processor 108, may cause the processor 108 to implement one or more embodiments of the present disclosure. The memory 106 may include a producer module 204, an assignment module 206, a transferring module 208, and a redemption module 210.

The producer module 204 plays a key role in the creation of IGV within the fence network. In particular, the producer module 204 in conjunction with the processor 108 may determine the base value, a unique alphanumeric key, and an expiration date to create the IGV. For example, the producer module 204 may receive a cost comprising the base value, administrative fee, and a predetermined incentive from a first user (e.g., a gifter) in a producer account before assigning ownership of the IGV to the first user. The IGV may include the predetermined incentive in a collateral account.

Once the IGV is created, the assignment module 206 in conjunction with the processor 108 may assign an ownership of the IGV to the first user upon receiving a purchase request from the first user and required information of the first user. Additionally, prior selling the IGV to the first user, the assignment module 206 may verify an authenticity and validity of the IGV by validating the alphanumeric key, the expiration date, and the predetermined incentive in the collateral account.

Thereafter, the transferring module 208 in conjunction with the processor 108 may facilitate the transfer of ownership of the IGV from the first user (gifter) to the second user (recipient). It operates based on a gift request received from the first user and required information of the second user. The required information of the first user and the second user may include corresponding users' details, users' account information, and users' proof of licenses or certifications.

The redemption module 210 in conjunction with the processor 108 may facilitate redemption of the IGV by the second user (recipient) within the fence network. It enables the recipient to utilize the IGV through participating enterprises associated with one of the fence networks. The redemption module 210 ensures a smooth redemption process, allowing the recipient to select and utilize the IGV at one or more enterprises within the network. The recipient may utilize the IGV for a commodity through one of the enterprises associated with the fence networks. The commodity may be a good purchased or a service utilized by the second user.

In some embodiments, the redemption module 210 may facilitate direct redemption of the IGV purchased by the first user (gifter). This means that the first user has the option to utilize the IGV themselves instead of transferring ownership to the second user (recipient) within the fence network. When the first user chooses to directly redeem the IGV, they may utilize it for their own benefit.

In some embodiments, the producer may also act as a gifter within the fence network This means that the producer may fund the IGV by providing the necessary amount, including the base value, administrative fee, and predetermined incentive, and distribute it as a promotional tool. By taking on a role of the gifter, the producer may proactively promote the use of IGVs within the fence network by offering them as gifts to recipients.

For example, the producer may allocate a certain budget for promotional purposes and use it to fund IGVs of various denominations. These IGVs may then be distributed to recipients as part of marketing campaigns, loyalty programs, or special promotions. By doing so, the producer not only encourages the adoption and use of IGVs but also increases the visibility and reach of the system within the fence network.

The lifespan of the IGV may be better explained by way of an exemplary embodiment. In the exemplary embodiment, consider an automotive IGV model with three available options i.e., $5000, $10,000, and $20,000. Each IGV includes a retailer incentive of $100 and an administrative fee of $200. When a gifter decides to purchase the $10,000 IGV. They pay the face value (e.g., base value) of $10,000, the incentive for the redeeming retailer (i.e., $100), and the producer's administrative fee (i.e., $200), totalling $10,300. The producer module 204 creates the IGV with its unique alphanumeric key and assigned an expiration date, while earmarking $10,100 for eventual reimbursement.

The gifter, now the owner of the $10,000 IGV, decides to transfer ownership to a recipient. They initiate a gift request and provide the required information of the recipient. The transferring module 208 may facilitate this transfer, ensuring that the ownership of the IGV is successfully transferred to the recipient.

The recipient, now the owner of the $10,000 IGV, decides to redeem it at a local dealership. They may visit the dealership and choose a vehicle with a price tag of $9,500. The redemption module 210 comes into play, facilitating the seamless redemption process. The dealership acknowledges the ownership transfer of the IGV and discounts the transaction by the value of the IGV ($10,000). As a result, the recipient doesn't need to pay any additional funds to cover the cost of the vehicle.

Following the transaction, the dealership has two options. They may either use the $10,000 IGV towards a $15,000 order of tires they are receiving the next week, effectively utilizing the IGV within the fence network. Alternatively, they may choose to cash out the IGV with the producer, thereby ending the IGV's cycle. In this example, the dealership decides to cash out. They select their preferred payment option, provide the necessary details, and receive a payment of $10,100 (minus any transaction fees associated with the chosen option) from the producer.

It should be noted that all such aforementioned modules 202-210 may be represented as a single module or a combination of different modules. Further, as will be appreciated by those skilled in the art, each of the modules 202-210 may reside, in whole or in parts, on one device or multiple devices in communication with each other. In some embodiments, each of the modules 202-210 may be implemented as dedicated hardware circuit comprising custom application-specific integrated circuit (ASIC) or gate arrays, off-the-shelf semiconductors such as logic chips, transistors, or other discrete components. Each of the modules 202-210 may also be implemented in a programmable hardware device such as a field programmable gate array (FPGA), programmable array logic, programmable logic device, and so forth. Alternatively, each of the modules 202-210 may be implemented in software for execution by various types of processors (e.g., processor 108). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module, and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for IGV management in fence networks. For example, the system 100 and the associated server 102 may manage IGV in the fence networks by the processes discussed herein. In particular, as will be appreciated by those of ordinary skill in the art, control logic and/or automated routines for performing the techniques and steps described herein may be implemented by the system 100 and the associated server 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

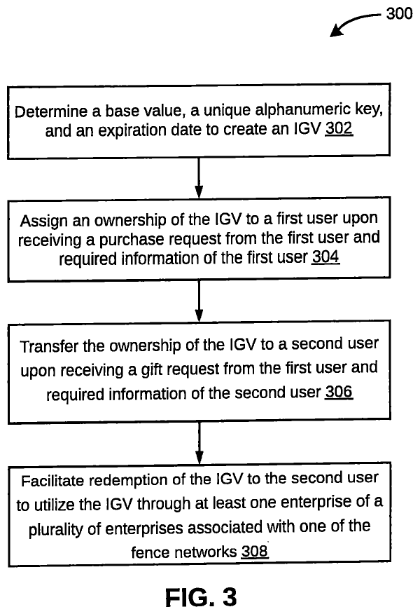

Referring now to FIG. 3, a flowchart 300 of a method for IGV management in fence networks is illustrated, in accordance with an embodiment. It should be noted that the steps 302-308 may be executed by the modules 202-210.

At step 302, a base value, a unique alphanumeric key, and an expiration date may be determined to create an IGV.

Once the IGV is created, at step 304, ownership of the IGV may be assigned to a first user upon receiving a purchase request from the first user and required information of the first user. In some embodiments, the producer may receive a cost including the base value, an administrative fee, and a predetermined incentive, from the first user, in a producer account, before assignment of the ownership of the IGV to the first user. It should be noted that the base value of the IGV and the predetermined incentive may be held in a separate account as collateral. The first user may correspond to a gifter.

In other words, the gifter may purchase the IGV by paying the base value, the administrative fee, and the predetermined incentive to the producer. The base value is an initial value, or a face value assigned to the IGV. It represents the monetary worth of the voucher that may be redeemed by a recipient. The administrative fee is an additional charge imposed by the producer. It is intended to cover the administrative costs associated with managing and operating the system. The administrative fee may help to support the infrastructure, maintenance, and services provided by the producer. Moreover, the predetermined incentive is a fixed amount offered to the redeeming retailer as an incentive for accepting and processing the IGV. It may encourage retailers to participate in the IGV management system and accept the vouchers as a payment method.

In some embodiments, the producer may verify an authenticity and validity of the IGV prior selling the IGV to the first user. The verification may include validating the alphanumeric key, the expiration date, and the predetermined incentive in the collateral account.

The alphanumeric key assigned to each IGV may serve as a unique identifier. During the validation process, the producer may compare the alphanumeric key provided by the first user with the corresponding key stored in a database. This comparison ensures that the key matches the one generated by the producer and hasn't been tampered with or duplicated. If the alphanumeric key is verified successfully, it confirms the authenticity of the IGV.

The expiration date may be set by the producer when the IGV is created. To validate the expiration date, the producer may compare a current date with the assigned expiration date of the IGV. If the current date is earlier than the expiration date, the IGV is considered valid and still within its usable timeframe. However, if the current date is later than the expiration date, the IGV is considered expired and may no longer be redeemable.

The predetermined incentive is an additional amount provided to the redeeming retailer as an incentive for accepting the IGV. To validate the predetermined incentive, the producer may verify whether the allocated funds for the incentive are present in the collateral account associated with the IGV. This verification ensures that the predetermined incentive is available and may be honoured when the IGV is redeemed.

upon receiving a gift request from the first user and required information of the second user, at step 306, the ownership of the IGV may be transferred to a second user. The second user may correspond to the recipient. The required information of the first user (gifter) and the second user (recipient) includes their corresponding user details, account information, and proof of licenses or certifications.

The user details may include personal information of the users, such as their full name, email address, billing and shipping address, phone number, and any other relevant contact information. The account information may include users account-related information, such as their chosen account name and password. This enables them to set up and access their accounts within the system. The account information may help in securely managing user profiles and facilitating transactions. Moreover, depending on the specific industry or market associated with the IGV, users may need to provide proof of licenses or certifications related to their eligibility or qualifications. This requirement ensures that the users comply with any necessary legal or regulatory requirements. For example, in industries like healthcare, finance, or legal services, users may need to provide proof of professional licenses or certifications to participate in the IGV management system.

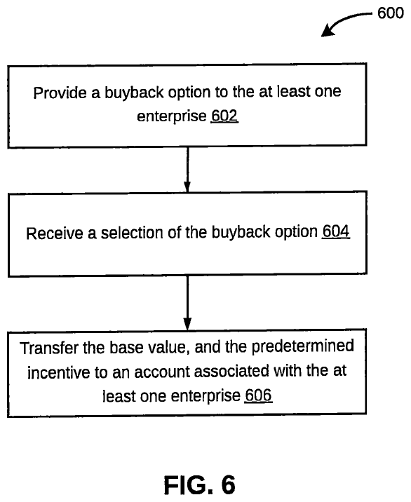

When transferring ownership of the IGV to the recipient, there are two possible scenarios to consider. In a first scenario, if the recipient already has an IGV account, the gifter may send the IGV directly to their account. In a second scenario, if the recipient does not have the IGV account, the gifter may create a placeholder account on their behalf, which may later be claimed by the recipient. The method for transferring the ownership to the second user is further explained in conjunction with FIG. 6.

Once the ownership is transferred to the second user, at step 308, redemption of the IGV may be facilitated to the second user to utilize the IGV through at least one enterprise of a plurality of enterprises associated with one of the fence networks. The IGV may be utilized for a commodity through at least one enterprise of the plurality of enterprises associated with the one of the fence networks. The commodity may be a good purchased or a service utilized by the second user. The plurality of enterprises may be an organisation, a business, a non-profit organisation, a producer's site, a retailer, distributors, suppliers, or an affiliated organisation.

To provide a clear understanding of the IGV management process, the process may be explained by way of an example. In this example, the producer offers three different IGV options for this market i.e., $20, $50, and $100. The producer also sets an administrative fee of $4 and a predetermined monetary incentive for buyback of $1. Additionally, the IGVs in this market have a 5-year expiration date. The creation of the IGV may be triggered in two ways i.e., when a gifter purchases the IGV directly from the producer, or when the producer acts as a gifter by funding the IGV and distributing it as a promotional tool. In either case, funds equivalent to the base value of the IGV, along with the predetermined monetary incentive, are held in a separate account as collateral for the issued IGV.

Let's consider a $20 IGV for this example. If the gifter does not have an account, they may send an anonymous gift. However, if they have an existing account or wish to create one, they may need to provide their full name, email address, choose an account name and password, and optionally provide additional information such as a profile picture, billing/shipping address, proof of military or veteran status, phone number, licenses held, EIN (Employer Identification Number), and alike. These optional provisions are not mandatory for purchasing and giving IGVs but may be required for certain functions within the IGV management system.

Once the gifter decides on a $20 IGV, they purchase it from the producer for $25. Out of the total amount, $21 is automatically allocated to a dedicated account for buyback by the producer, and the producer collects their administrative fee of $4. At this point, the IGV is considered to be created. The producer assigns the IGV an expiration date, which is set to 5 years from the date of issue and generates a unique alphanumeric key for tracking purposes. The information related to the IGV, including its expiration date and alphanumeric key, is stored in a producer's database, enabling seamless transfer of ownership, and providing a historical timeline for each IGV.

The gifter may view the newly created IGV in their wallet on the IGV site or an application. Multiple IGVs owned by the gifter are displayed in groups, such as “$20 IGV x2, $50 IGV x0, $100 IGV x1,” allowing for easy inspection of individual IGVs. The IGVs are sorted based on their expiration dates, with priority given to the IGVs that are closest to expiration. At this stage, the IGV is considered to be in “Public Circulation”, ready to be utilized by the gifter or transferred to a recipient.

Once the IGV is transferred to the recipient, the recipient now owns the IGV. The recipient may then choose to redeem the IGV on the producer's site for goods or services either through affiliate businesses/organizations or directly from the producer.

If the recipient chooses the affiliate option, the order is processed by the affiliate, and the IGV funds are allocated to the producer's account. The affiliate is paid by the producer based on the agreed schedule (e.g., end of the business day, weekly, monthly). If the recipient decides to donate the IGV, the producer may facilitate the donation to a charity or nonprofit organization relevant to the industry.

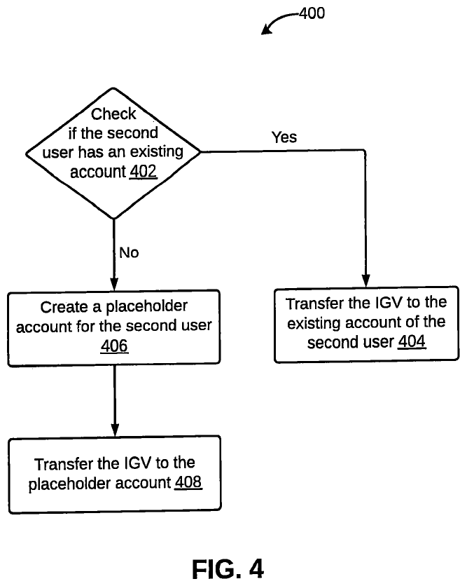

Referring now to FIG. 4, a flowchart 400 of a method for transferring ownership of IGV to a second user is illustrated, in accordance with an embodiment of the present disclosure. With reference to step 306 in FIG. 3, in order to transfer the ownership of the IGV to the second user (e.g., recipient), initially the first user (e.g., gifter) may check if the second user has an existing account at step 402.

If the second user has the existing account, then at step 404, the IGV may be transferred to the existing account of the second user. In order to transfer the IGV to the existing account of the second user i.e., the recipient, the gifter may use an option in the IGV site or application to send one of their IGVs to the account holder recipient. Further, the gifter may select a specific IGV, which is transferred from the gifter to the recipient.

If the second user doesn't have the existing account, then at step 406, a placeholder account may be created for the second user. More particularly, to create a placeholder account for the recipient, the gifter may input the recipient's name and email. The email provided may be notified, and the email owner may claim the placeholder account by setting up an account.

Further, at step 408, the IGV may be transferred to the placeholder account. It should be noted that this placeholder account may serve as a temporary storage for the IGV until the second user claims it. Later on, the second user may claim the placeholder account by setting up their own IGV account, ensuring a smooth transition of ownership. Once the second user sets up their own IGV account, any vouchers held in the placeholder account are automatically transferred to the recipient's newly made account. Subsequently, the placeholder account is deleted, and the IGV is securely housed in the recipient's account for their future use.

Alternatively, the gifter may provide a scannable QR code as a physical or digital voucher to the recipient that does not have the IGV account. The scannable code may be used by the recipient for redeeming the IGV through the at least one enterprise.

When the recipient receives the physical voucher and scans it, they are directed to the IGV producer's site or application. Upon scanning, the recipient is notified that they have received a voucher from the gifter (unless it was sent anonymously). They are prompted to set up an account by following the account setup process provided on the IGV producer's platform.

Before finalizing the exchange, a party (for example, the gifter) giving the IGV may be shown a warning, stating that this is not a reversible transaction. The gifter may be asked to review the information and confirm that everything is correct. Once the gifter confirms, the transfer of ownership may be finalized, and the recipient now becomes the rightful owner of the IGV.

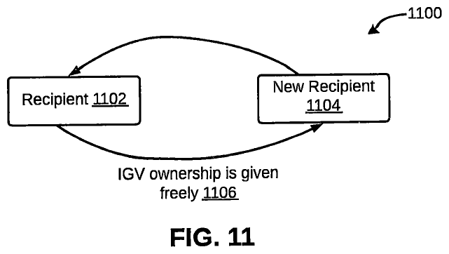

In the event that the recipient decides to re-gift the IGV to a new recipient, the process outlined above may be repeated for the relevant parties. It should be noted that repeating the transfer process has no effect on the expiration date of the IGV, which was initially set at the time of its creation. This transfer and re-gifting process can be repeated indefinitely until the IGV reaches its expiration date. The method of re-gifting the IGV to the new recipient is further explained in conjunction with FIG. 11.

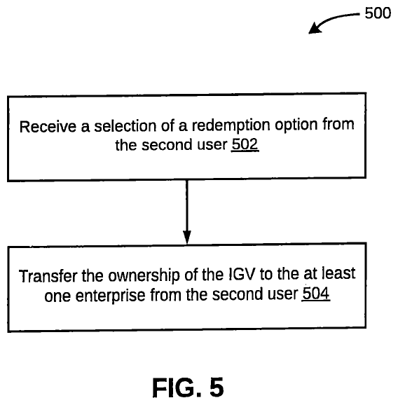

Referring now to FIG. 5, a flowchart 500 of a method for facilitating redemption of IGV to a second user is illustrated, in accordance with an embodiment of the present disclosure. With reference to step 308 in FIG. 3, in order to facilitate the redemption of the IGV to the second user, a selection of a redemption option may be received from the second user at step 502. It should be noted that the redemption option may be associated with at least one enterprise.

Based on the selection of the redemption option, at step 504, the ownership of the IGV may be transferred to at least one enterprise from the second user, after deducting a transaction fee from an account associated with the second user. Thus, the enterprises 114 may interact with the system 100 to accept IGVs as a payment, offer goods or services for redemption, or participate in the buyback process. The method for buyback of IGV is explained in greater detail in conjunction with FIG. 6.

In a more elaborative way, once the recipient has received the IGV, the recipient may redeem the IGV by selecting at least one option that works best for them from the available redemption options. A first redemption option may include redeem their IGV on the producer's site for goods or services through an affiliate business or organization, or for goods or services offered directly from the producer.

If the recipient selects this option, it completes the IGV process. In particular, the recipient agrees to the transfer, and the funds associated with the IGV are allocated to the producer's account. The recipient's order is processed by the affiliate, and the affiliate is paid by the producer according to the agreed-upon schedule (e.g., end of the business day, every Monday, on the 15th of each month, once the balance reaches a certain threshold).

A second redemption option may include donation of the IGV. In this option, the producer allows the recipient to donate the IGV to a charity or nonprofit of their choosing, as long as it is industry relevant. The producer remits funds to the specified organization on the recipient's behalf in batches on a monthly basis. This option also completes the IGV process, as the recipient agrees to the transfer, and the funds are allocated to the producer's account.

A third redemption option may include redeem their IGV at a fence link for goods or services. The fence link may be defined as an individual closed-loop business or organization within the fence network. In this option, the recipient may choose to redeem their IGV at a physical or online location operated by the fence link. They select their desired goods or services, and the fence link verifies the validity of the IGV. Once verified, the fence link completes the transaction by taking ownership of the IGV using existing or proprietary integration technology and delivers the indicated goods or services. This option puts the IGV in a fence network circulation, allowing for further transactions within the fence network. The fence network circulation may be referred to stages for IGVs in which they are owned by persons or entities within the fence network.

Referring now to FIG. 6, a flowchart 600 of a method for buyback of IGV is illustrated, in accordance with an embodiment of the present disclosure. With reference to step 504 in FIG. 5, once the ownership of the IGV is transferred to the at least one enterprise from the second user, the producer may provide a buyback option to the at least one enterprise at step 602. The buyback option may refer to a process in which the producer offers an opportunity for the at least one enterprise to sell back the IGV they acquired from the second user. This buyback option allows the enterprise to transfer the ownership of the IGV back to the producer in exchange for a specified amount. It should be noted that the producer may set up this buyback option in advance as an automatic process when certain thresholds are met, or it may be done as a manual process on the producer's site or application.

At step 604, the buyback option may be selected by at least one enterprise. The producer may provide the fence link with the buyback option, allowing them to sell back the acquired IGV. This option may be presented on the producer's platform, where the fence link may select it as a desired course of action. As mentioned earlier in reference to FIG. 5, in the case of the third redemption option, the recipient transfers ownership of the IGV to the fence link and does not complete the IGV process. The fence link has the options of selling the IGV back to the producer, thereby completing the IGV process.

In this option, the fence link agrees to relinquish ownership of the IGV in exchange for the funds allocated for the IGV, including the predetermined monetary incentive for buyback. In continuation to the previous example, referring to the $20 IGV with a $1 incentive for buyback, the total amount due to the fence link is $21. Fees associated with the transfer follow a tiered schedule and are deducted from the amount transferred to the fence link. The fees are determined by the producer and dictated by current rates. The producer may offer multiple payment options, each with its own fee schedule, allowing the fence link to choose which one is best for them. With the $20 IGV example, the producer may deduct the $1.49 fee from the $21 total. The producer processes the payment of $19.51 to the fence link.

Thereafter, at step 606, the base value and the predetermined incentive may be transferred to an account associated with the at least one enterprise. The producer transfers the funds owed to the enterprise, including the base value and the predetermined incentive, as agreed upon in the buyback process. This completes the buyback transaction, and the IGV process for that particular IGV is now finished.

Apart from selling the IGV back to the producer, the fence link may also have the option of transferring the IGV, individually or by batch, to another fence link in the same fence network in exchange for goods or services. For instance, let's revisit the automotive IGV example mentioned earlier. The fence link, in this case, a car dealership, owns a $10,000 IGV that they wish to use for a $15,000 order of tires from a tire manufacturer who is also the fence link within the same network.

This option benefits the dealership as the ownership transfer of the IGV is instantaneous, eliminating the need for depositing funds in a bank and waiting for clearance. The tire manufacturer, on the other hand, benefits from receiving ownership of the IGV, which entitles them to the incentive for buyback if they choose to sell it back to the producer.

In this scenario, the tire manufacturer agrees to take ownership of the IGV in exchange for a $10,000 discount on their tire order. The transfer process is facilitated through the producer's platform, and once the balance is due, the tire manufacturer collects the remaining amount and completes the transaction.

As a fence link owner of the IGV, they have the flexibility to utilize any option mentioned in this section. This transfer option may be repeated multiple times for the same IGV and throughout the entire lifespan of the IGV.

Further, the fence link has the option to distribute IGVs they own as promotions or distribute them to their employees. This follows the same exchange procedure detailed previously, where the ownership of the IGV is transferred to the recipient. By distributing the IGVs, the IGVs are taken out of the fence network circulation and returned to a public circulation. The public circulation may be referred to a phase of an IGV's lifespan when it is available for general circulation and may be obtained by users who are not part of the fence network. During this phase, the IGV may be purchased, gifted, or otherwise transferred between individuals or entities outside the fence network.

Another option available to the fence links is to wait for expiration reconciliation. Most of the IGV's lifespan may be spent in public circulation before transitioning to fence network circulation. If the IGV expires while in public circulation, the funding associated with that IGV is released to the producer. To prevent any manipulation of near-expiration IGVs and allow flexibility for the fence links accepting close-to-expiry IGVs, all IGVs in the fence network circulation are automatically bought back by the producer one day before their expiration date. The producer's platform follows the preferred method of payment specified by the fence link for the buyback process. If no preferred method is indicated, the producer utilizes the option with the lowest associated fee. The IGV is then de-listed from the “active IGV database” and filed in a separate “filled IGV” database, marking the completion of the IGV process.

To better understand how the IGVs may be used in real-life situations, consider different scenarios in which individuals or organizations make use of the IGV management system for activities like personal gifting, financial assistance, and charitable initiatives.

Consider a scenario where Bob wants to celebrate his son's academic success in college, so he decides to send him a thoughtful gift. Bob purchases a $50 Restaurant IGV and sends it to his son, who is located out-of-state. Upon receiving the IGV, his son may choose to redeem it at a restaurant listed as a fence link by the producer. The son decides to use the IGV to receive a $50 discount on his meal at the chosen restaurant. This example demonstrates how IGVs can be used for personal gifting purposes, allowing individuals to send meaningful gifts to their loved ones.

Consider another scenario where Pete learns that his sister's husband has recently been laid off, and he wants to help alleviate their financial burden. Pete decides to provide his sister with a Grocery IGV subscription to support her budgeting efforts. He selects the value and duration of the subscription, such as $75 per week for 2 months. The IGVs are delivered according to Pete's chosen schedule, and his sister may use them at her local supermarket, which is listed as a Fence Link. By using the Grocery IGVs, Pete's sister may receive discounts on her groceries, helping her manage her expenses during this challenging period.

Moreover, consider a scenario where a nonprofit organization aims to assist low-income individuals with their energy bills. They collaborate with the IGV producer to implement a fundraising campaign. The nonprofit purchases batches of $100 Energy IGVs and distributes them to those in need. Additionally, they are listed as a recipient organization to which individuals may donate their unwanted IGVs. This allows the nonprofit to support their cause while providing energy assistance to disadvantaged individuals within the community. Through the utilization of IGVs, the nonprofit successfully raises funds and helps alleviate the burden of energy expenses for those in need.

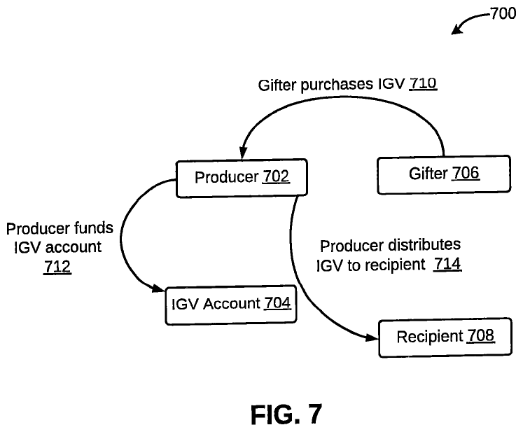

Referring now to FIG. 7, an exemplary process flow 700 for creation of IGV by gifter is illustrated, in accordance with an embodiment of the present disclosure. The process flow 700 starts with the gifter 706 deciding to purchase an IGV from the producer 702, at step 710. The gifter 706 selects the desired IGV option and proceeds with the purchase by providing the necessary payment.

Upon receiving the payment from the gifter 706, the producer 702 allocates the funds to the IGV account 704, at step 712. These funds are set aside and held in a dedicated account specifically for the issued IGV.

Once the funds are allocated, the producer 702 transfers the ownership of the IGV from the gifter 706 to the intended recipient 708, at step 714. This transfer involves moving the IGV from the gifter's account to the recipient's IGV account.

With the successful transfer, the recipient 708 becomes the new owner of the IGV. They now have the rights and privileges associated with the IGV and may proceed with redeeming it for goods or services.

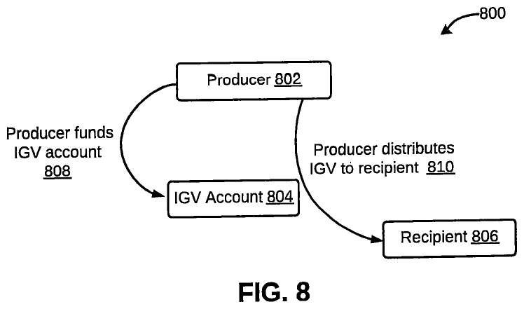

Referring now to FIG. 8, an exemplary process flow 800 for creation of IGV by producer is illustrated, in accordance with an embodiment of the present disclosure. The process flow 800 starts with the producer 802 receiving funds from various sources, such as gifter purchases or promotional activities.

These funds are then allocated to the IGV account 804, at step 808. The IGV account 804 serves as a repository for the allocated funds specifically designated for creating and managing IGVs. The account ensures that there are sufficient funds available to meet the demand for IGVs within the designated fence network.

Once the necessary funds are available in the IGV account 804, the producer 802 proceeds to distribute IGVs to recipient 806, at step 810. In particular, the producer 802 may select a recipient, who could be an individual or an organization, and transfers the ownership of the IGV from the producer's account to the recipient's IGV account.

Upon successful distribution, the recipient 806 becomes the new owner of the IGV. The IGV is now associated with the recipient's account, allowing them to utilize the IGV within the designated fence network. The recipient may redeem the IGV for goods, services, or other benefits offered by participating businesses or organizations.

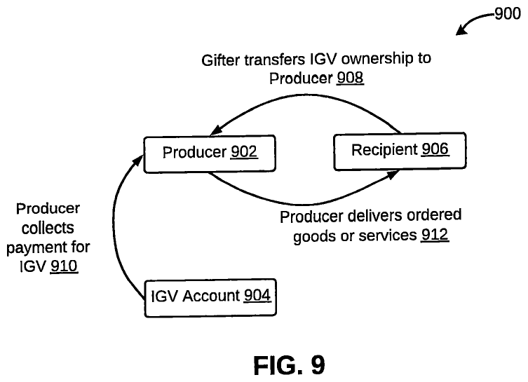

Referring now to FIG. 9, an exemplary process flow 900 for transferring IGV from recipient to producer for goods or services is illustrated, in accordance with an embodiment of the present disclosure. The process flow 900 begins with the producer 902, acting as a gifter, transferring the ownership of the IGV to the recipient 906, at step 908. The producer selects and assigns the IGV to the recipient 906, indicating their intention to gift the IGV.

Once the producer 902 has transferred the ownership, the recipient 906 receives the IGV. The recipient 906 now becomes the new owner of the IGV and gains control over its redemption.

As the producer is also the original issuer of the IGV, the producer 902 may collect payment from the recipient 906 for the value of the IGV, at step 910. The payment serves as compensation to the producer 902 for the issued IGV.

After receiving payment, if applicable, the producer 902 fulfils the recipient's order by delivering the goods or services associated with the redeemed IGV, at step 912. This step ensures that the recipient receives the intended benefits of the IGV.

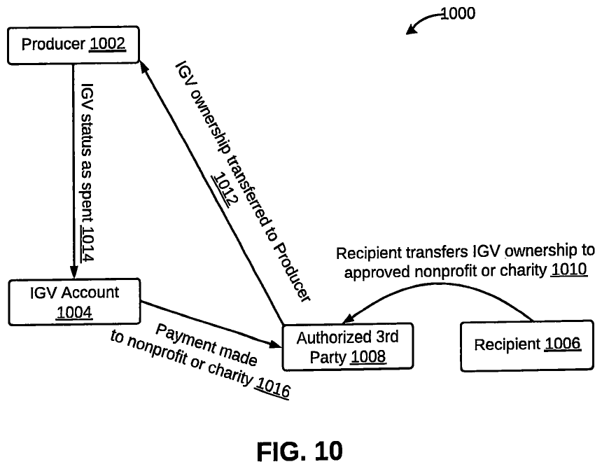

Referring now to FIG. 10, an exemplary process flow 1000 for donating IGV by recipient to producer to nonprofit is illustrated, in accordance with an embodiment of the present disclosure. The process flow 1000 begins with the recipient 1006, who currently owns the IGV, transferring the ownership of the IGV to an approved nonprofit or charity, at step 1010. The recipient 1006 selects the specific nonprofit or charity to whom they wish to donate the IGV.

After the recipient 1006 has transferred the ownership to the nonprofit or charity, the nonprofit or charity, acting on behalf of the producer 1002, transfers the ownership of the IGV to the producer 1002, at step 1012. This step ensures that the producer 1002 is now the new owner of the IGV.

As a result of the donation, the producer 1002, as a gesture of support, makes a payment to the approved nonprofit or charity, at step 1016. This payment serves as a contribution to the nonprofit or charity for their involvement in the donation process.

Once the ownership transfer and payment are complete, the status of the IGV is updated to “spent” in the IGV account 1004, at step 1014. This designation indicates that the IGV has been successfully utilized for charitable purposes.

An authorized third party, represented as Authorized 3rd Party 1008 in the process flow 1000, may be involved in facilitating the transfer of ownership to the producer 1002 and ensuring the smooth execution of the donation process. This third party helps to ensure compliance, security, and transparency throughout the transaction.

Referring now to FIG. 11, an exemplary process flow 1100 for transferring of IGV from recipient to new recipient is illustrated, in accordance with an embodiment of the present disclosure. The process flow 1100 begins with the original recipient 1102 of the IGV deciding to transfer the ownership of the IGV to a new recipient 1104. This decision may be based on various reasons, such as the recipient 1102 wanting to share the gift with someone else or not having a personal use for the IGV.

The original recipient 1102 freely gives the ownership of the IGV to the new recipient 1104, at step 1106. This transfer of ownership is a voluntary act without any monetary exchange or transaction involved.

Once the ownership of the IGV is transferred, the new recipient 1104 becomes the new owner of the IGV. They may now utilize the IGV according to its terms and condition.

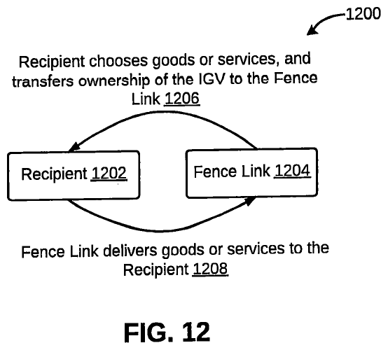

Referring now to FIG. 12, an exemplary process flow 1200 for transferring of IGV from recipient to fence link is illustrated, in accordance with an embodiment of the present disclosure. The recipient 1202 is the current owner of the IGV and wishes to utilize it for goods or services offered by a fence link 1204.

The fence link 1204 is a business or organization that is part of the fence network and accepts IGVs as a form of payment. They offer goods or services that may be redeemed using the IGV.

The recipient 1202 selects the desired goods or services offered by the fence link 1204 and agrees to transfer the ownership of the IGV to the fence link 1204 as payment, at step 1206. This transfer of ownership may be done through a digital platform or any other suitable means.

Once the ownership of the IGV is transferred to the fence link 1204, the fence link 1204 provide the selected goods or services to the recipient 1202. This may include delivering physical goods, providing access to digital content, or any other form of fulfilling the recipient's chosen redemption option.

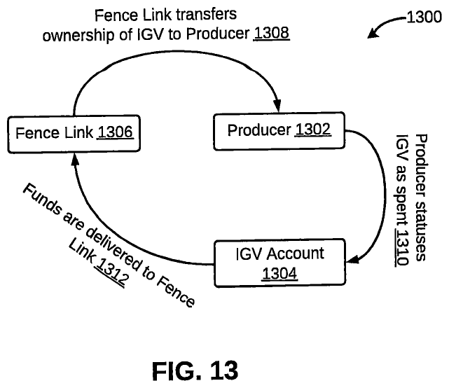

Referring now to FIG. 13, an exemplary process flow 1300 for transferring of IGV from fence link to producer is illustrated, in accordance with an embodiment of the present disclosure. The process flow 1300 starts with the fence link 1306 initiating the transfer of ownership of the IGV back to the producer 1302, at step 1308. This may be done through a digital platform or any other suitable means.

Upon transferring the ownership of the IGV, the producer 1302 delivers the agreed-upon funds to the fence link 1306, at step 1312. The funds may be transferred electronically, through a designated payment method, or any other suitable arrangement.

The IGV account 1304 is the dedicated account where the producer 1302 holds funds associated with IGVs, including the funds allocated for buybacks. After the transfer is completed and the funds are delivered to the fence link 1306, the producer 1302 updates the status of the IGV in the system to mark it as spent, at step 1310. This indicates that the IGV has been returned and the transaction is finalized.

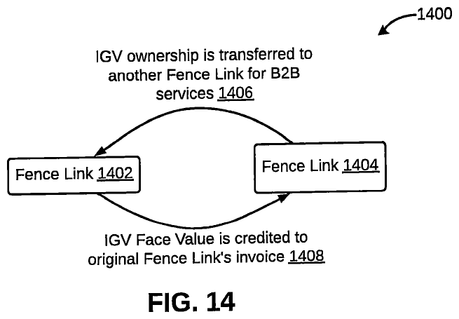

Referring now to FIG. 14, an exemplary process flow 1400 for transferring of IGV from fence link to fence link is illustrated, in accordance with an embodiment of the present disclosure. The fence link 1402 currently holds ownership of the IGV and wishes to transfer it to another fence link 1404. The fence link 1404 agrees to accept the IGV from the fence link 1402 in exchange for B2B (business-to-business) services or any other agreed-upon arrangement.

The fence link 1402 initiates the transfer process by transferring the ownership of the IGV to the fence link 1404, at step 1406. This transfer may be facilitated through a digital platform or any other suitable means.

Upon receiving the ownership of the IGV, the fence link 1404 credits the base value of the IGV to the original fence link's invoice, at step 1408. This effectively provides a credit or discount equivalent to the base value of the IGV to the fence link 1402 for their services or purchases within the B2B arrangement.

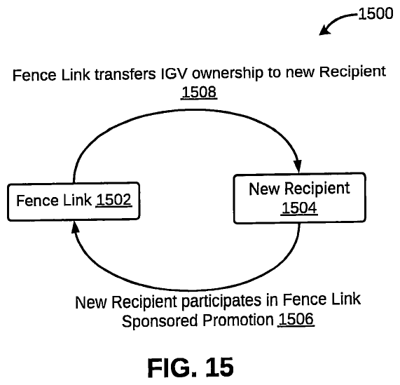

Referring now to FIG. 15, an exemplary process flow 1500 for transferring of IGV from fence link to new recipient is illustrated, in accordance with an embodiment of the present disclosure. As part of the transfer process, the new recipient 1504 may participate in a promotion or special offer sponsored by the fence link 1502, at step 1506. This may include discounts, incentives, or other benefits provided by the fence link 1502 to the new recipient 1504.

The fence link 1502 transfers the ownership of the IGV to the new recipient 1504, officially transferring the rights and benefits associated with the IGV, at step 1508. This transfer may be facilitated through digital platforms, physical vouchers, or any other suitable means.

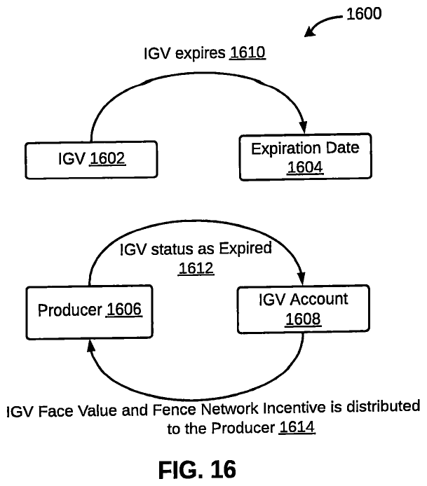

Referring now to FIG. 16, an exemplary process flow 1600 for IGV expiration while in general circulation is illustrated, in accordance with an embodiment of the present disclosure. Once the expiration date 1604 is reached, the IGV 1602 is considered expired and no longer usable for redemption. The status of the IGV is updated accordingly to reflect its expired state, at step 1612.

When the IGV 1602 expires while in general circulation, at step 1610 the face value of the IGV 1602 and any associated incentives or funds held in the IGV account 1608 are distributed to the producer 1606, at step 1614. This ensures that all funds associated with the expired IGV are returned to the producer 1606.

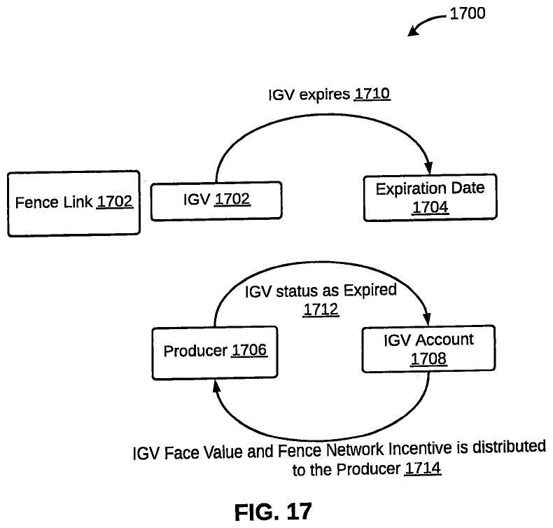

Referring now to FIG. 17, an exemplary process flow 1700 for IGV expiration while in fence network circulation is illustrated, in accordance with an embodiment of the present disclosure. When the expiration date 1704 is reached, the IGV 1702 is considered expired and no longer valid for redemption, even within the fence network 1702.

The status of the IGV 1702 is updated to indicate that it has expired while in fence network circulation, at step 1712. When the IGV 1702 expires while in fence network circulation, at step 1710, the face value of the IGV and any associated incentives or funds held in the IGV account 1708 are distributed to the producer 1706, at step 1714. This ensures that all funds associated with the expired IGV are returned to the producer 1706.

As will be appreciated by those skilled in the art, the techniques described in the various embodiments discussed above are not routine, or conventional, or well understood in the art. The present disclosure addresses various issues and provides solutions to the following problems as discussed below:

For the giver: The IGV offers assurance that the gift may be used as intended. It eliminates logistical and legal restrictions that may arise when shipping certain gifts. It also provides the opportunity for the giver to offer a thoughtful gift related to the recipient's interests, even if the giver lacks in-depth knowledge about those interests. For example, Joe wants to get a gift for his sister's husband who likes wine. Instead of choosing a specific bottle that may not suit his recipient's tastes, Joe can opt to give an alcohol IGV, allowing the recipient to select their own bottle from a local retailer.

For the recipient: The IGV provides an easy and versatile payment option. Redeeming the voucher includes transferring ownership to the redeeming retailer during the point of sale. If the recipient has no interest in the specific market associated with the IGV, they have the option to transfer it to another recipient or donate it to a charity/nonprofit related to the industry.

For the retailer: Participating in the IGV management system enhances visibility for retailers by placing them alongside their market peers as part of a larger fence network. Retailers agree to discount a sale up to the value of the IGV in exchange for ownership of the voucher. Once transferred, the IGV becomes fully owned by the retailer, including any remaining value unused by the recipient. Retailers may also utilize the IGV as a payment option for other organizations within the fence network. Additionally, retailers have the option to sell the IGV back to the IGV producer, who buys back valid IGVs at their face value and provides an additional predetermined monetary incentive to offset any associated cash-out fees. This offers retailers a chance to commodify IGVs and provides smaller fence links with an opportunity that was previously unavailable.

For regulators: The IGV management system may assist regulators in keeping controlled items within legal and regulated systems. Participating retailers must be licensed businesses in their operating areas, ensuring the exclusion of black and grey markets from the program. The system also ensures that recipients are subject to the retailer's age verification processes, already established and sanctioned by regulatory authorities. Moreover, IGVs may be utilized as a spending distribution tool to promote growth within specific industries as deemed appropriate by local, state, and federal governments. For example, in an Energy IGV scenario, IGVs could be employed by government agencies to assist low-income residents in paying their electric or gas bills. With a set expiration date, IGVs ensure that all associated funds circulate back into the economy.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

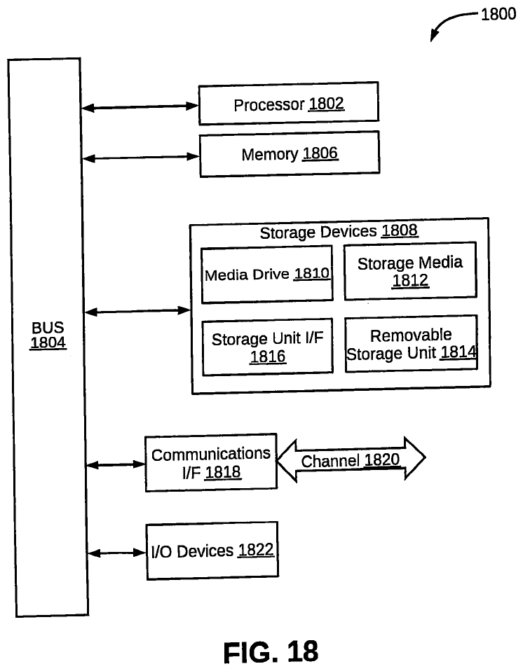

The disclosed methods and systems may be implemented on a conventional or a general-purpose computer system, such as a personal computer (PC) or server computer. Referring now to FIG. 18, an exemplary computing system 900 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 900 may represent, for example, a user device such as a desktop, a laptop, a mobile phone, personal entertainment device, DVR, and so on, or any other type of special or general-purpose computing device as may be desirable or appropriate for a given application or environment. The computing system 1800 may include one or more processors, such as a processor 1802 that may be implemented using a general or special purpose processing engine such as, for example, a microprocessor, microcontroller, or other control logic. In this example, the processor 902 is connected to a bus 1804 or other communication medium. In some embodiments, the processor 1802 may be an Artificial Intelligence (AI) processor, which may be implemented as a Tensor Processing Unit (TPU), or a graphical processor unit, or a custom programmable solution Field-Programmable Gate Array (FPGA).

The computing system 1800 may also include a memory 1806 (main memory), for example, Random Access Memory (RAM) or other dynamic memory, for storing information and instructions to be executed by the processor 1802. The memory 906 also may be used for storing temporary variables or other intermediate information during execution of instructions to be executed by the processor 1802. The computing system 1800 may likewise include a read only memory (“ROM”) or other static storage device coupled to bus 904 for storing static information and instructions for the processor 1802.

The computing system 1800 may also include a storage device 1808, which may include, for example, a media drive 1810 and a removable storage interface. The media drive 1810 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1812 may include, for example, a hard disk, magnetic tape, flash drive, or other fixed or removable medium that is read by and written to by the media drive 1810. As these examples illustrate, the storage media 1812 may include a computer-readable storage medium having stored therein particular computer software or data.

In alternative embodiments, the storage devices 908 may include other similar instrumentalities for allowing computer programs or other instructions or data to be loaded into the computing system 1800. Such instrumentalities may include, for example, a removable storage unit 1814 and a storage unit interface 1816, such as a program cartridge and cartridge interface, a removable memory (for example, a flash memory or other removable memory module) and memory slot, and other removable storage units and interfaces that allow software and data to be transferred from the removable storage unit 1814 to the computing system 1800.

The computing system 1800 may also include a communications interface 1818. The communications interface 1818 may be used to allow software and data to be transferred between the computing system 900 and external devices. Examples of the communications interface 1818 may include a network interface (such as an Ethernet or other NIC card), a communications port (such as for example, a USB port, a micro-USB port), Near field Communication (NFC), etc. Software and data transferred via the communications interface 1818 are in the form of signals which may be electronic, electromagnetic, optical, or other signals capable of being received by the communications interface 1818. These signals are provided to the communications interface 1818 via a channel 1820. The channel 1820 may carry signals and may be implemented using a wireless medium, wire or cable, fiber optics, or other communications medium. Some examples of the channel 1820 may include a phone line, a cellular phone link, an RF link, a Bluetooth link, a network interface, a local or wide area network, and other communications channels.

The computing system 1800 may further include Input/Output (I/O) devices 1822. Examples may include, but are not limited to a display, keypad, microphone, audio speakers, vibrating motor, LED lights, etc. The I/O devices 1822 may receive input from a user and also display an output of the computation performed by the processor 1802. In this document, the terms “computer program product” and “computer-readable medium” may be used generally to refer to media such as, for example, the memory 1806, the storage devices 1808, the removable storage unit 1814, or signal(s) on the channel 1820. These and other forms of computer-readable media may be involved in providing one or more sequences of one or more instructions to the processor 1802 for execution. Such instructions, generally referred to as “computer program code” (which may be grouped in the form of computer programs or other groupings), when executed, enable the computing system 1800 to perform features or functions of embodiments of the present invention.

In an embodiment where the elements are implemented using software, the software may be stored in a computer-readable medium and loaded into the computing system 1800 using, for example, the removable storage unit 1814, the media drive 1810 or the communications interface 1818. The control logic (in this example, software instructions or computer program code), when executed by the processor 1802, causes the processor 1802 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of Industry Gift Voucher (IGV) management in fence networks comprising:
determining, by a producer and through a server, a base value, a unique alphanumeric key, and an expiration date to create an IGV;
assigning, by the producer and through the server, an ownership of the IGV to a first user upon receiving a purchase request from the first user and required information of the first user;
transferring, by the first user and through the server, the ownership of the IGV to a second user upon receiving a gift request from the first user and required information of the second user; and
facilitating, by the server, redemption of the IGV to the second user to utilize the IGV through at least one enterprise of a plurality of enterprises associated with one of the fence networks, wherein the IGV is circulated within the fence networks.

2. The method of claim 1, wherein the IGV is utilized for a commodity through the at least one enterprise of the plurality of enterprises associated with the one of the fence networks.

3. The method of claim 1, further comprises receiving, by the producer and through the server, a cost comprising the base value, an administrative fee, and a predetermined incentive, from the first user, in a producer account, before assignment of the ownership of the IGV to the first user.

4. The method of claim 1, wherein facilitating further comprises:
receiving, through the server, a selection of a redemption option from the second user, wherein the redemption option is associated with the at least one enterprise; and
transferring, through the server, the ownership of the IGV to the at least one enterprise from the second user, based on the selection of the redemption option, after deducting a transaction fee from an account associated with the second user.

5. The method of claim 3, further comprising:
providing, by the producer and through the server, a buyback option to the at least one enterprise;
selecting, by the at least one enterprise and through the server, the buyback option; and
transmitting, by the producer and through the server, the base value, and the predetermined incentive to an account associated with the at least one enterprise.

6. The method of claim 3, wherein the IGV comprises the predetermined incentive in a collateral account.

7. The method of claim 6, further comprising verifying an authenticity and validity of the IGV prior selling the IGV to the first user, wherein the verification comprises validating the alphanumeric key, the expiration date, and the predetermined incentive in the collateral account.

8. The method of claim 1, wherein transferring the ownership of the IGV to the second user comprises:
at least one of
transferring the IGV to an existing account of the second user; or
performing,
creating a placeholder account for the second user; and
transferring the IGV to the placeholder account.

9. The method of claim 1, wherein the plurality of enterprises are closed-loop entities within the fence networks that agree to discount up to the base value of the IGV in exchange for the ownership of the IGV.

10. The method of claim 1, further comprising generating a transaction history associated with the IGV, wherein the transaction history comprises information regarding purchases of the IGV, transfers of the IGV, redemptions of the IGV, and donations of the IGV.

11. The method of claim 1, further comprising generating a scannable code for the second user for redeeming the IGV through the at least one enterprise.

12. The method of claim 1, wherein the required information of the first user and the second user comprises corresponding users' details, users' account information, and users' proof of licenses or certifications.

13. A system for Industry Gift Voucher (IGV) management in fence networks comprising:
a processor; and
a memory communicatively coupled to the processor, wherein the memory stores processor-executable instructions, which, on execution, cause the processor to:
determine a base value, a unique alphanumeric key, and an expiration date to create an IGV;
assign an ownership of the IGV to a first user upon receiving a purchase request from the first user and required information of the first user;
transfer the ownership of the IGV to a second user upon receiving a gift request from the first user and required information of the second user; and
facilitate redemption of the IGV to the second user to utilize the IGV through at least one enterprise of a plurality of enterprises associated with one of the fence networks, wherein the IGV is circulated within the fence networks.

14. The system of claim 13, wherein the IGV is utilized for a commodity through the at least one enterprise of the plurality of enterprises associated with the one of the fence networks.

15. The system of claim 13, wherein the processor-executable instructions further cause the processor to receive a cost comprising the base value, an administrative fee, and a predetermined incentive, from the first user, in a producer account, before assignment of the ownership of the IGV to the first user.

16. The system of claim 13, wherein the processor-executable instructions further cause the processor to facilitate redemption of the IGV by:
receiving a selection of a redemption option from the second user, wherein the redemption option is associated with the at least one enterprise; and
transferring the ownership of the IGV to the at least one enterprise from the second user, based on the selection of the redemption option, after deducting a transaction fee from an account associated with the second user.

17. The system of claim 15, wherein the processor-executable instructions further cause the processor to:
provide a buyback option to the at least one enterprise;
select the buyback option; and
transmit the base value, and the predetermined incentive to an account associated with the at least one enterprise.

18. The system of claim 13, wherein the processor-executable instructions further cause the processor to transfer the ownership of the IGV to the second user by:
at least one of
transferring the IGV to an existing account of the second user; or
performing,
creating a placeholder account for the second user; and
transferring the IGV to the placeholder account.

19. The system of claim 13, wherein the processor-executable instructions further cause the processor to generate a transaction history associated with the IGV, wherein the transaction history comprises information regarding purchases of the IGV, transfers of the IGV, redemptions of the IGV, and donations of the IGV.

20. The system of claim 13, wherein the required information of the first user and the second user comprises corresponding users' details, users' account information, and users' proof of licenses or certifications.

21. A non-transitory computer-readable medium storing computer-executable instructions for Industry Gift Voucher (IGV) management in fence networks, the computer-executable instructions configured for:
determining a base value, a unique alphanumeric key, and an expiration date to create an IGV;
assigning an ownership of the IGV to a first user upon receiving a purchase request from the first user and required information of the first user;
transferring the ownership of the IGV to a second user upon receiving a gift request from the first user and required information of the second user; and
facilitating redemption of the IGV to the second user to utilize the IGV through at least one enterprise of a plurality of enterprises associated with one of the fence networks, wherein the IGV is circulated within the fence networks.
